(19) United States
(12) Patent Application Publication
(10) Pub. No.: US 2005/0251644 A1
(43) Pub. Date: Nov. 10, 2005

(54) Physics processing unit instruction set architecture

(76) Inventors: Monier Maher, St. Louis, MO (US); Jean Pierre Bordes, St. Charles, MO (US); Dilip Sequeira, St. Louis, MO (US); Richard Tonge, St. Louis, MO (US)

Correspondence Address: Stephen R. Whitt, 1215 Tottenham Court, Reston, VA, 20194, US

(21) Appl. No.: 10/839,155

(22) Filed: May 6, 2004

(51) Int. Cl. G06F 15/00

(52) U.S. Cl. 712/2

(57) ABSTRACT

An efficient quasi-custom instruction set for Physics Processing Unit (PPU) is enabled by balancing the dictates of a parallel arrangement of multiple, independent vector processors and programming considerations. A hierarchy of multiple, programmable memories and distributed control over data transfer is presented.

### BACKGROUND OF THE INVENTION

The present invention relates to circuits and methods adapted to generate real-time physics animations. More particularly, the present invention relates to an integrated circuit architecture for a physics processing unit.

Recent developments in computer games have created an expanding appetite for sophisticated, real-time physics animations. Relatively simple physics-based simulations and animations (hereafter referred to collectively as “animations”) have existed in several conventional contexts for many years. However, cutting edge computer games are currently a primary commercial motivator for the development of complex, real-time, physics-based animations.

Any visual display of objects and/or environments interacting in accordance with a defined set of physical constraints (whether such constraints are realistic or fanciful) may generally be considered a “physics-based” animation. Animated environments and objects are typically assigned physical characteristics (e.g., mass, size, location, friction, movement attributes, etc.) and thereafter allowed to visually interact in accordance with the defined set of physical constraints. All animated objects are visually displayed by a host system using a periodically updated body data derived from the assigned physical characteristics and the defined set of physical constraints. This body of data is generically referred to hereafter as “physics data.”

Historically, computer games have incorporated some limited physics-based animation capabilities within game applications. Such animations are software based and implemented using specialized physics middle-ware running on a host system's Central Processing Unit (CPU), such as a Pentium®. “Host systems” include, for example, Personal Computers (PCs) and console gaming systems.

Unfortunately, the general purpose design of conventional CPUs dramatically limit the scale and performance of conventional physics animations. Given a multiplicity of other processing demands, conventional CPUs lack the processing time required to execute the complex algorithms required to resolve the mathematical and logic operations underlying a physics animation. That is, a physics-based animation is generated by resolving a set of complex mathematical and logical problems arising from the physics data. Given typical volumes of physics data and the complexity and number of mathematical and logic operations involved in a “physics problem,” efficient resolution is not a trivial matter.

The general lack of available CPU processing time is exacerbated by hardware limitations inherent in the general purpose circuits forming conventional CPUs. Such hardware limitations include an inadequate number of mathematical/logic execution units and data registers, a lack of parallel execution capabilities for mathematical/logic operations, and relatively slow data transfers. Simply put, the architecture and operating capabilities of conventional CPUs are not well correlated with the computational and data transfer requirements of complex physics-based animations. This is true despite the speed and super-scalar nature of many conventional CPUs. The multiple logic circuits and look-ahead capabilities of conventional CPUs can not overcome the disadvantages of an architecture characterized by a relatively limited number of execution units and data registers, a lack of parallelism, and inadequate memory bandwidth.

In contrast to conventional CPUs, so-called super-computers like those manufactured by Cray® are characterized by massive parallelism. Further, while programs are generally executed on conventional CPUs using Single Instruction-Single Data (SISD) operations, super-computers typically include a number of vector processors executing Single Instruction-Multiple Data (SIMD) operations. However, the advantages of massively parallel execution capabilities come at enormous size and cost penalties within the context of super-computing. Practical commercial considerations largely preclude the approach taken to the physical implementation of conventional super-computers.

Thus, the problem of incorporating sophisticated, real-time, physics-based animations within applications running on conventional host systems remains unmet. Software-based solutions to the resolution of all but the most simple physics problems have proved inadequate. As a result, a hardware-based solution to the generation and incorporation of real-time, physics-base animations has been proposed in several related and commonly assigned U.S. patent applications Ser. Nos. 10/715,459; 10/715,370; and 10/715,440 all filed Nov. 19, 2003. The subject matter of these applications is hereby incorporated by reference.

As described in the above referenced applications, the frame rate of the host system display necessarily restricts the size and complexity of the physics problems underlying the physics-based animation in relation to the speed with which the physics problems can be resolved. Thus, given a frame rate sufficient to visually portray an animation in real-time, the design emphasis becomes one of increasing data processing speed. Data processing speed is determined by a combination of data transfer capabilities and the speed with which the mathematical/logic operations are executed. The speed with which the mathematical/logic operations are performed may be increased by sequentially executing the operations at a faster rate, and/or by dividing the operations into subsets and thereafter executing selected subsets in parallel. Accordingly, data bandwidth considerations and execution speed requirements largely define the architecture of a system adapted to generate physics-based animations in real-time. The nature of the physics data being processed also contributes to the definition of an efficient system architecture.

### SUMMARY OF THE INVENTION

In one aspect, the data processing speed of the present invention is increased by intelligently expanding the parallel computational capabilities afforded by a system architecture adapted to efficiently resolve physics-based problems. Increased “parallelism” is accomplished within the present invention by, for example, the use of multiple, independent vector processors and selected look-ahead programming techniques. In a related aspect, the present invention makes use of Single Instruction-Multiple Data (SIMD) operations communicated to parallel data processing unit via Very Long Instruction Words (VLIW).

The size of the vector data operated upon by the multiple vector processors is selected within the context of the present invention such that the benefits of parallel data execution and need for programming coherency remain well balanced. When used, a properly selected VLIW format enables the simultaneous control of multiple floating point execution units and/or one or more scalar execution units. This approach enables, for example, single instruction word definition of floating-point operations on vector data structures.

In another aspect, the present invention provides a specialized hardware circuit (a so-called “Physics Processing Unit (PPU) adapted to efficiently resolve physics problems using parallel mathematical/logic execution units and a sophisticated memory/data transfer control scheme. Recognizing the need to balance parallel computational capabilities with efficient programming, the present invention contemplates alternative use of a centralized, programmable memory control unit and a distributed plurality of programmable memory control units.

A further refinement of this aspect of the present invention, contemplates a hierarchical architecture enabling the efficient distribution, transfer and/or storage of physics data between defined groups of parallel mathematical/logic execution units. This hierarchical architecture may include two or more of the following: a master programmable memory control circuit located in a control engine having overall control of the PPU; a centralized programmable memory control circuit generally associated a circuit adapted to transfer between a PPU level memory and lower level memories (e.g., primary and secondary memories); a plurality of programmable memory control circuits distributed across a plurality of parallel mathematical/logic execution units grouping, and a plurality of primary memories each associated with one or more data processing units.

In yet another aspect, the present invention describes an exemplary grouping of mathematical/logic execution units, together with an associated memory and data registers, as a Vector Processing Unit (VPU). Each VPU preferably comprises multiple data processing units accessing at least one VPU memory and implementing multiple execution threads in relation to the resolution of a physics problem defined by selected physics data. Each data processing unit preferably comprises both execution units adapted to execute floating-point operations and scalar operations.

### BRIEF DESCRIPTION OF THE DRAWINGS

In the drawings, like reference characters indicate like elements. The drawings, taken together with the foregoing discussion, the detailed description that follows, and the claims, describe a preferred embodiment of the present invention. The drawings include the following:

FIG. 1 is block level diagram illustrating one preferred embodiment of a Physics Processing Unit (PPU) designed in accordance with the present invention;

FIG. 2 further illustrates an exemplary embodiment of a Vector Processing Unit (VPU) in some additional detail;

FIG. 3 further illustrates an exemplary embodiment of a processing unit contained with the VPU of FIG. 2 in some additional detail;

FIG. 4 further illustrates exemplary and presently preferred constituent components of the common memory/register portion of the VPU of FIG. 2; and,

FIG. 5 further illustrates exemplary and presently preferred constituent components, including selected data registers, of the processing unit of FIG. 3.

### DETAILED DESCRIPTION OF THE PREFERRED EMBODIMENT(S)

The present invention will now be described in the context of one or more preferred embodiments. These embodiments describe in one aspect an integrated chip architecture that balances expanded parallelism with control programming efficiency.

Expanded parallelism, while facilitating data processing speed, requires some careful additional consideration in its impact on programming overhead. For example, some degree of networking is required to coordinate the transfer of data to, and the operation of multiple independent vector processors. This networking requirement adds to the programming burden. The use of Very Long Instruction Words (VLIWs) also increases programming complexity. Multi-threading data transfers and multiple thread execution further complicate programming.

Thus, the material advantages afforded by a hardware architecture specifically tailored to efficiently transfer physics data and to execute the mathematical/logic operations required to resolve sophisticated physics problems must be balanced against a rising level of programming complexity. In several related aspects, the present invention strikes a balance between programming efficiency and a physics-specialized, parallel hardware design.

Additional inventive aspects of the present invention are also described with reference to one or more preferred embodiments. The embodiments are described as teaching examples. The scope of the present invention is not limited to the teaching examples, but is defined by the claims that follow.

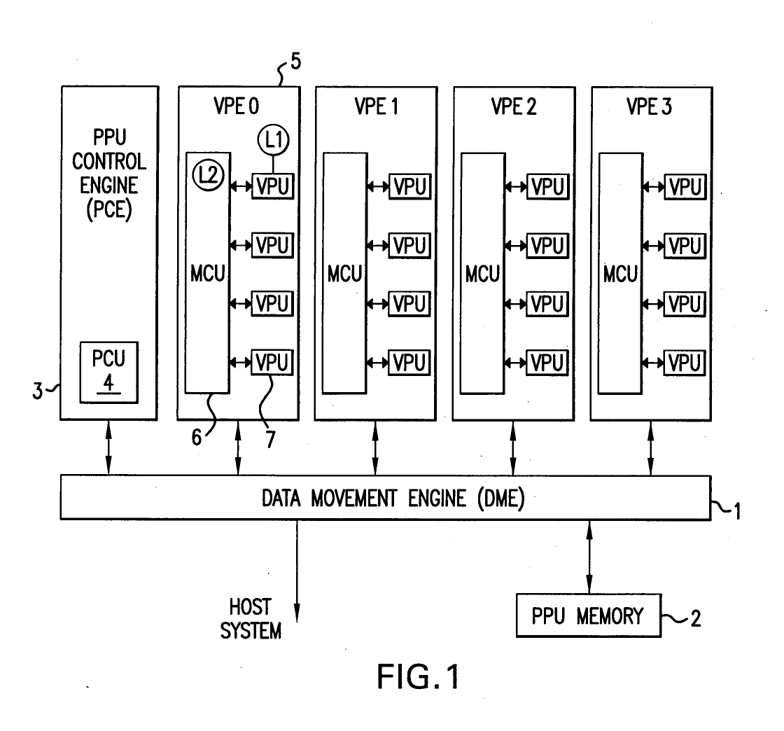

One embodiment of the present invention is shown in FIG. 1. Here, data transfer and data processing elements are combined in a hardware architecture characterized by the presence of multiple, independent vector processors. As presently preferred, the illustrated architecture is provided by means of an Application Specific Integrated Circuit (ASIC) connected to (or connected within) a host system. Whether implemented in a single chip or a chip set this hardware will hereafter be generically referred to as a Physics Processing Unit (PPU).

Of note, the circuits and components described below are functionally partitioned for ease of explanation. Those of ordinary skill in the art will recognize that a certain amount of arbitrary line drawing is necessary in order to form a coherent description. However, the functionality described in the following examples might be otherwise combined and/or further partitioned in actual implementation by individual adaptations of the present invention. This well understood reality is true for not only the respective PPU functions, but also for the boundaries between the specific hardware and software elements in the exemplary embodiment(s). Many routine design choices between software, hardware, and/or firmware are left to individual system designers.

For example, the expanded parallelism characterizing the present invention necessarily implicates a number of individual data processing units. A term “data processing unit” refers to a lower level grouping of mathematical/logic execution units (e.g., floating point processors and/or scalar processors) that preferably access data from a primary memory, (i.e., a lowest memory in a hierarchy of memories within the PPU). Effective control of the numerous, parallel data processing units requires some organization or control designation. Any reasonable collection of data processing units is termed hereafter a “Vector Processing Engine (VPE).” The word “vector” in this term should be read a generally descriptive but not exclusionary. That is, physics data is typically characterized by the presence of vector data structures. Further, the expanded parallelism of the present invention is designed in principal aspect to address the problem of numerous, parallel vector mathematical/logic operations applied to vector data. However, the computational functionality of a VPE is not limited to only floating-point vector operations. Indeed, practical PPU implementations must also provide efficient data transfer and related integer and scalar operations.

The data processing units collected within an individual VPE may be further grouped within associated subsets. The teaching examples that follow suggest a plurality of VPEs, each having four (4) associated data processing grouping terms “Vector Processing Units VPUs). Each VPU comprises dual (A & B) data processing units, wherein each data processing unit includes multiple floating-point execution units, multiple scalar processing units, at least one primary memory, and related data registers. This is a preferred embodiment, but those of ordinary skill in the art will recognize that the actual number and arrangement of data processing units is the subject of numerous design choices.

The exemplary PPU architecture of FIG. 1 generally comprises a high-bandwidth PPU memory 2, a Data Movement Engine (DME) 1 providing a data transfer path between PPU memory 2 (and/or a host system) and a plurality of Vector Processing Engines (VPEs) 5. A separate PPU Control Engine (PCE) 3 may be optionally provided to centralize overall control of the PPU and/or a data communications process between the PPU and host system.

Exemplary implementations for DME 1, PCE 3 and VPE 5 are given in the above referenced and incorporated applications. As presently preferred, PCE 3 is an off-the-shelf RISC processor core. As presently preferred, PPU memory 2 is dedicated to PPU operations and is configured to provide significant data bandwidth, as compared with conventional CPU/DRAM memory configurations. As an alternative to programmable MCU approached described below, DME 1 may includes some control functionality (i.e., programmability) adapted to optimize data transfers to/from VPEs 5, for example. In another alternate embodiment, DME 1 comprises little more than a collection of cross-bar connections or multiplexors, for example, forming a data path between PPU memory 2 and various memories internal to the PPU and/or the plurality of VPEs 5. In a related aspect, the PPU may use conventionally understood ultra- (or multi-) threading techniques such that operation of DME I and one or more of the plurality of VPEs 5 is simultaneously enabled.

Data transfer between the PPU and host system will generally occur through a data port connected to DME 1. One or more of several conventional data communications protocols, such as PCI or PCI-Express, may be used to communicate data between the PPU and host system.

Where incorporated within a PPU design, PCE 3 preferably manages all aspects of PPU operation. A programmable PPU Control Unit (PCU) 4 is used to store PCE control and communications programming. In one preferred embodiment, PCU 4 comprises a MIPS64 5Kf processor core from MIPS Technologies, Inc. PCE 3 may communicate with the CPU of a host system via a PCI bus, a Firewire interface, and/or a USB interface, for example. PCE 3 is assigned responsibility for managing the allocation and use of memory space in one or more internal, as well as externally connected memories. As an alternative to the MCU-based control functionality described below, PCE 3 might be used to control some aspect(s) of data management on the PPU. Execution of programs controlling operation of VPEs 5 may be scheduled using programming resident in PCE 3 and/or DME 1, as well as the MCU.

The term “programmable memory control circuit” is used to broadly describe any circuit adapted to transfer, store and/or execute instruction code defining data transfer paths, moving data across a data path, storing data in a memory, or causing a logic circuit to execute a data processing operation.

As presently preferred, each VPE 5 further comprises a programmable memory control circuit generally indicated in the preferred embodiment as a Memory Control Unit (MCU) 6. The term MCU (and indeed the term “unit” generally) should not be read as drawing some kind of hardware box within the architecture described by the present invention. MCU 6 merely implements one or more functional aspects of the overall memory control function with the PPU. In the embodiment shown in FIG. 1, multiple programmable memory control circuits, termed MCUs, are distributed across the plurality of VPEs.

Each VPE further comprises a plurality of grouped data processing units. In the illustrated example, each VPE 5 comprises four (4) Vector Processing Units (VPUs) 7 connected to a corresponding MCU 6. Alternatively, one or more additional programmable memory control circuit(s) is included within DME 1. In yet another alternative, the functions implemented by the distributed MCUs in the embodiment shown in FIG. 1 may be grouped into a centralized, programmable memory control circuit within DME 1 or PCE 3. This alternate embodiment allows removal of the memory control function from individual VPEs.

Wherever physically located, the MCU functionality essentially controls the transfer of data between PPU memory 2 and the plurality of VPEs 5. Data, usually including physics data, may be transferred directly from PPU memory 2 to one or more memories associated with individual VPUs 7. Alternatively, data may be transferred from PPU memory 2 to an “intermediate memory” (e.g., an inter-engine memory, a scratch pad memory, and/or another memory associated with a VPE 5), and thereafter transferred to a memory associated with an individual VPU 7.

In a related aspect, MCU functionality may further define data transfers between PPU memory 2, a primary (L1) memory, and one or more secondary (L2) memories within a VPE 5. (As presently preferred, there are actually two kinds of primary memory; data memory and instruction memory. For the sake of clarity, only data memories are described herein, but it should be noted that an L1 instruction memory is typically associated with each VPU thread (e.g., thread A and thread)). A “secondary memory” is defined as an intermediate memory associated with a VPE 5 and/or DME 1 between PPU memory 2 and a primary memory. A secondary memory may transfer data to/from one or more of the primary memories associated with one or more data processing units resident in a VPE.

In contrast, a “primary memory” is specifically associated with at least one data processing unit. In presently preferred embodiments, data transfers from one primary memory to another primary memory typically flow through a secondary memory. While this implementation is not generally required, it has several programming and/or control advantages.

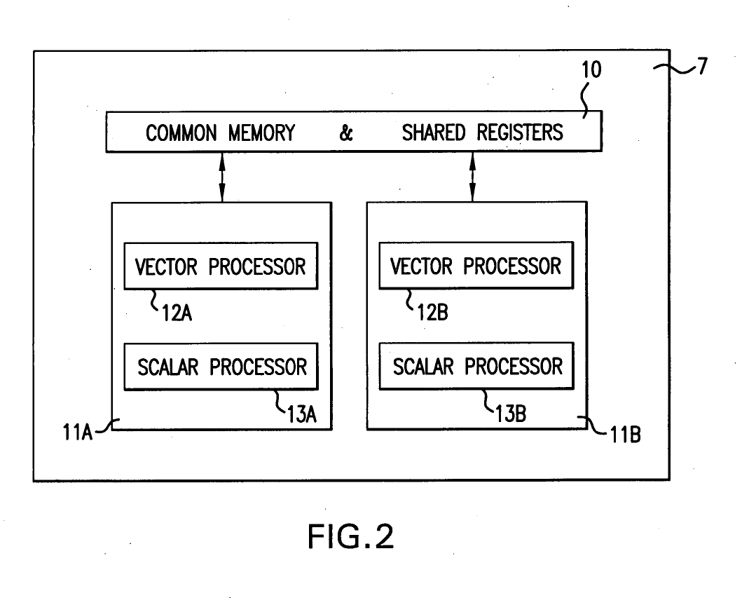

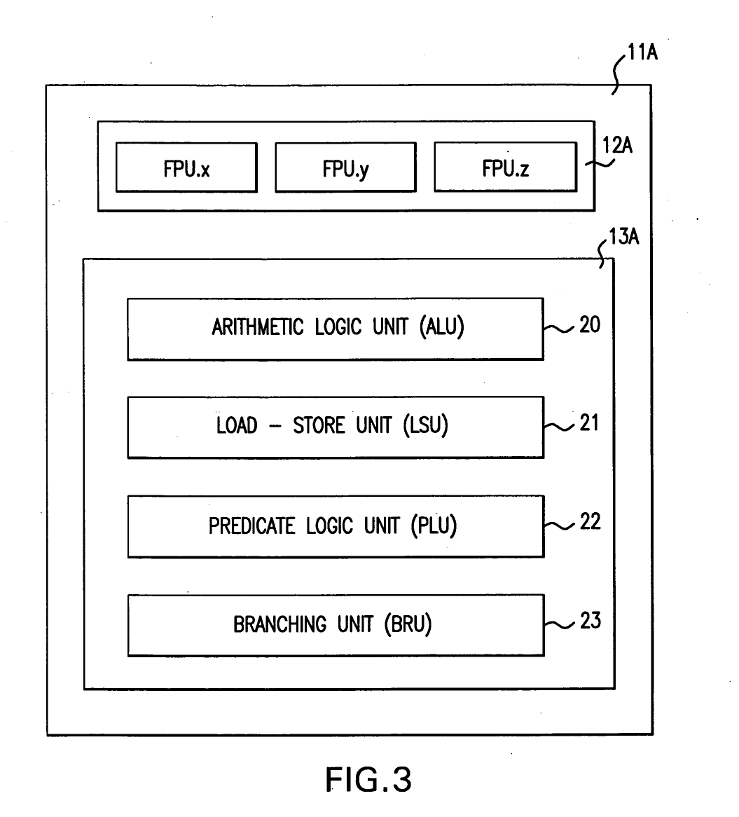

An exemplary grouping of data processing units within a VPE is further illustrated in FIGS. 2 and 3. As presently contemplated, sixteen (16) VPUs are arranged in parallel within four (4) VPEs to form the core of the exemplary PPU.

FIG. 2 conceptually illustrates major functional components of a single VPU 7. In the illustrated example, VPU 7 comprises dual (A & B) data processing units 11A and 11B. As presently preferred, each data processing unit is a VLIW processor having an associated memory and registers, and program counter. VPU 7 further comprises a common memory/register portion 10 shared by data processing units 11A and 11B. Parallelism within VPU 7 is obtained through the use of two independent threads of execution. Each execution thread is controlled by a stream of instructions (e.g., a sequence of individual 64-bit VLIWS) that enables floating-point and scalar operations for each thread. Each stream of instructions associated with an individual execution thread is preferably stored in an associated instruction memory. The instructions are executed in one or more “mathematical/logic execution units” dedicated to each execution thread. (A dedicated relationship between execution thread and executing hardware is preferred but not required within the context of the present invention).

An exemplary collection of mathematical/logic execution units is further illustrated in FIG. 3. The collection of logic execution units may be generally grouped into two classes; units performing floating-point arithmetic operations (either vector or scalar), and units performing integer operations (either vector or scalar). As presently preferred, a full complement of vector floating-point units is used, whereas integer units are typically scalar. However, different combinations of vector/scalar as well as floating-point/integer units are contemplated within the context of the present invention. Taken collectively, the units performing floating-point vector arithmetic operations are generally termed a “vector processor” 12A, and units performing integer operations are termed an “scalar processor” 13A.

In a related exemplary embodiment, vector processor 12A comprises three (3) Floating-Point execution Units (FPUs) (x, y, and x) that combine to execute floating point vector arithmetic operations. Each FPU is preferably capable of issuing a multiply-accumulate operation during every clock cycle.

Scalar processor 13A comprises logic circuits enabling typical programming instructions. For example, scalar processor 13A generally comprises a Branching Unit (BRU) 23 adapted to execute all instructions affecting program flow, such as branches, jumps, and synchronization instructions. As presently preferred, the VPU uses a “load and store” type architecture to access data memory. Given this preference, each scalar processor preferably comprises a Load-Store Unit (LSU) 21 adapted to transfer data between at least a primary memory and one or more of the data registers associated with VPU 7. LSU 21 may also be used to transfer data between VPU registers. Each instruction thread is also provided with an Arithmetic/Logic Unit (ALU) 20 adapted to perform, as examples, scalar, integer-based mathematical operations, logic, and comparison operations.

Optionally, each data processing unit (11A and 11B) may include a Predicate Logic Unit (PLU) 22. Each PLU is adapted to execute a special class of logic operations on data stored in predicate registers provided in VPU 7.

With the foregoing configuration of dual data processing units (11A and 11B) executing dual (first and second) instruction streams, the exemplary VPU can operate in at least two fundamental modes. In a standard dual-thread mode of operation, first and second threads are executed independent one from the other. In this mode, each BRU 23 operates on only its local program counter. Each execution thread can branch, jump, synchronize, or stall independently. While operating in standard dual-thread mode, a loose form of data processing unit synchronization is achieved by the use of a specialized “SYNC” instruction.

Alternatively, the dual data processing units (11A and 11B) may operate in a lock-step mode, where the first and second execution threads are tightly synchronized. That is, whenever one thread executes a branch or jump instruction, the program counters for both threads are updated. As a result, when one thread stalls due to a SYNC instruction or hazard, both threads stall.

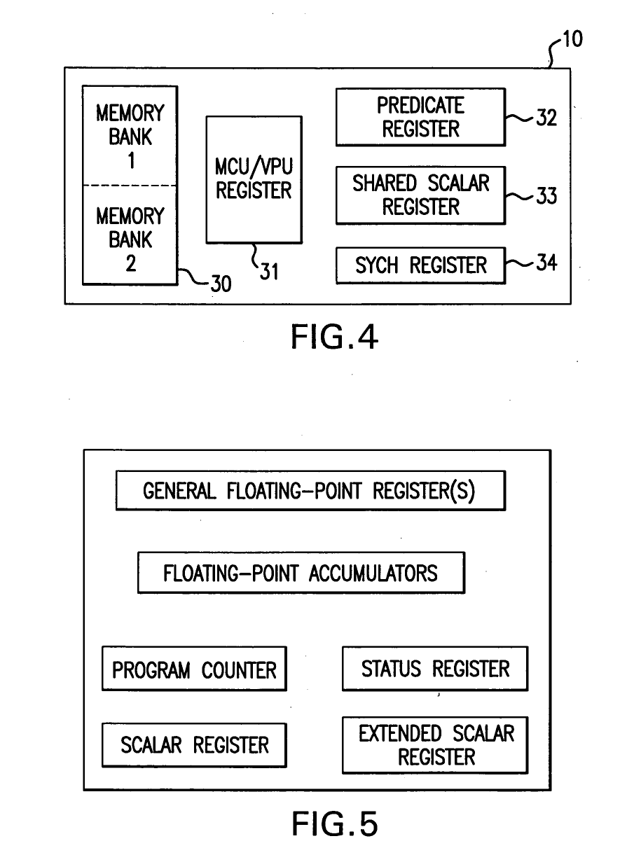

An exemplary register structure is illustrated in FIGS. 4 and 5 in relation to the working example of a VPU described thus far with reference to FIGS. 2 and 3. Those of ordinary skill in the art will recognize that the definition and assignment of data registers is almost entirely a matter of design choice. In theory a single register could be used for all instructions. But obvious practical considerations require some number and size of data registers, or sets of data registers. Nonetheless, a presently preferred collection of data registers will be described.

The common memory/register portion 10 of VPU 7 preferably comprises a dual-bank memory commonly accessible by both data processing units. The common memory is referred as a “VPU memory” 30. VPU memory 30 is one specific example of a primary memory implementation.

As presently contemplated, VPU memory 30 comprises 8 Kbytes of local memory, arranged in two banks of 4 Kbytes each. The memory is addressed in words of 32-bits (4-bytes) each. This word size facilitates storing standard 32-bit floating point numbers in VPU memory. Vectors values can be stored starting at any address in VPU memory 30.

Physically, VPU memory 30 is preferably arranged in rows storing data comprised of multiple (e.g., 4) data words. Accordingly, one addressing scheme uses a most significant address bit to identify one of the two memory banks, eight bits to identify a row within the identified memory bank, and another two bits to identify a data word in the row. As presently preferred, each bank of VPU memory 30 has two (2) independent, bi-directional access ports, each capable of performing either a Read or a Write operation (but not both) on any four (4) consecutive words of memory per clock cycle. The four (4) words can begin at any address and need not be aligned in any special way.

Each memory bank can independently operate in one of three presently preferred operating modes. In a first mode, both access ports are available to the VPU. In a second mode, one port is available to the VPU and the other port is available to an MCU circuit resident in the corresponding VPE. In a third mode, both ports are available to the MCU circuit (one port for Read, the other port for Write).

If the LSUs 21 associated with each data processing unit attempt to simultaneously access a bank of memory while the memory is in the second mode of operation (i.e., one VPU port and one MCU port), a first LSU will be assigned priority, while the second thread is stalled for one clock cycle. (This outcome assumes that the VPU is not operating in “lock-step” mode).

As presently contemplated, VPU 7 uses “little-endian” byte ordering, which means the lowest numbered byte should contain the least significant bits of a 32-bit word. Other byte ordering schemes may be used, but it should be recognized that byte ordering is particularly important where data is transferred directly between the VPU and either the PCE or the host system.

With reference again to FIG. 4, common memory/register portion 10 further comprises a plurality of communication registers 31 forming a low latency, data communications path between the VPU and a MCU circuit resident in a corresponding VPE or in the DME. Several specialized (e.g., global) registers, such as predicate registers 32, shared predicate registers 22, and synchronization registers 34 are also preferably included with the common memory/register portion 10. Each data processing unit (11A and 11B) may draw upon resources in the common memory/register portion of VPU 7 to implement an execution thread.

Where used, predicate registers 32 are shared by both data processing units (11A and 11B). Data stored in a predicate register can be used, for example, to predicate floating-point register-to-register move operations and as the condition for a conditional branch operation. Predicate registers can be updated by various FPU instructions as well as by LSU instructions. PLU 22 (in FIG. 3) is dedicated to performing a variety of bit-wise logic operations on date stored in predicate registers 32. In addition, the contents of a predicate register can be copied to/from one or more of the scalar registers 33.

When a predicate register is updated by an FPU instruction or by a LSU instruction, it is typically treated as two concatenated 3-element flag vectors. These two flag vectors can be made to contain, for example, sign and zero flags, respectively, or the less-than and less-than-or-equal-to flags, respectively, etc. One bit in a relevant instruction word controls which sets of flags are stored in the predicate register.

Respective data processing units may use a synchronization register 34 to synchronize program execution with an external event. Such events can be signaled by the MCU, DME, or another instruction thread.

Each one of the dual processing units (again only processing unit 11A is shown) preferably comprises a number of dedicated registers (or register sets) and/or logic circuits. Those of ordinary skill in the art will further recognize that the specific placement of registers and logic circuits within a PPU designed in accordance with the present invention is also highly variable in relation to a individual design choices. For example, any one or all of the registers and logic circuits identified in relation to an individual data processing unit in the working example(s) may alternatively be placed within the common memory/register section 10 of VPU 7. However, as presently preferred, each execution thread will be supported by one or more dedicated registers (or registers sets) and/or logic circuits in order to facilitate independent instruction thread execution.

Thus, in the example shown in FIG. 5, a multiplicity of general purpose floating-point (GPFP) registers 40 and floating-point (FP) accumulators 41 are associated with vector processor 12A. The GPFP registers 40 and FP accumulators 41 can be referenced as 3-element vectors or as scalars.

As presently contemplated, one or more of the GPFP registers can be assigned special characteristics. For example, selected registers may be designated to always return certain vector values or data forms when Read. When used as a destination operand, a GPFP register need not be modified, yet status flags and predicate flags are still updated normally. Other selected GPFP registers may be defined to provide access to the FP accumulators. With some restrictions, the GPFP registers can be used as a source or destination operand with most FPU instructions. Selected GPFP registers may implicitly be used by where certain vector data load/store operations.

In addition to the GPFP registers 40 and FP accumulators 41, processing unit 11A of FIG. 5 further comprises a program counter 42, status register(s) 43, scalar registers(s) 44, and/or extended scalar registers 45. However, this is just and exemplary collection of scalar registers. Scalar registers are typically used to implement, as example, loop operations and load/store address calculations.

Each instruction thread normally updates a pair of status registers. A first instruction thread A updates a status register in the first processing unit and the second instruction thread updates a status register in the second processing unit. However, where it is not necessary to distinguish between threads, a common status register may be used. Dedicated and shared status registers contain dynamic status flags associated with FPU operations and are respectively updated every time an FPU instruction is performed. However, status flags are not typically updated by ALU, LSU, PLU, or BRU instructions.

Overflow flags in status register(s) 43 indicate when the result of an operation is too large to fit into the standard (e.g., 32-bit) floating-point representation used by the VPU. Similarly, underflow flags indicate when the result of the operation is too small. Invalid flags in the status registers 43 indicate when an invalid arithmetic operation has been performed, such as dividing by zero, taking the square root of a negative number, or improperly comparing infinite values. A Not-a-Number (NaN) flag is set if the result of a floating-point operation is not a valid number which can occur, for example, whenever a source operand is not a number vale, or in the case of zero being divided by zero, or infinity being divided by infinity. Overflow, underflow, invalid, and NaN flags corresponding to each vector element (x, y, and z) may be provided in the status registers.

The present invention further contemplate the use of certain “sticky” flags within the context of status register(s) 43 and/or one or more global registers. Once set, sticky flags remain set until explicitly cleared. Four such sticky flags correspond to exceptions normally identified in status registers 43 (i.e., overflow, underflow, invalid, and division-by-zero). In addition certain status flags may be used to indicate stalls, illegal instructions, and memory access conflicts.

The first and second threads of execution within VPU 7 are preferably controlled by respective BRUs (23 in FIG. 3). Each BRU maintains a program counter 42. In the standard (or dual-threaded) mode of VPU operation, each BRU executes branch, jump, and SYNC instructions and updates its program counter accordingly. This allows each thread to run independently of the other. In the “lock-step” mode, however, whenever either BRU takes a branch or jump, both program counters are updated, and whenever either BRU executes a SYNC instruction, both threads stall until the synchronization condition is satisfied. This mode of operation forces both program counters to always remain equal to each other.

VPU 7 preferably uses a 64-bit, fixed-length instruction word (VLIW) for each execution thread. Each instruction word comprises two instruction slots, where each instruction slot contains an instruction executable by a mathematical/logic execution unit, or in the case of a SIMD instruction by one or more logic execution unit. As presently preferred, each instruction word often comprises a floating-point instruction to be executed by a vector processor and an scalar instruction to be executed by one of the scalar processor in a processing unit. Thus, a single VLIW within an execution thread communicates to a particular data processing unit both a floating-point instruction and an scalar instruction which are respectively executed in a vector processor and an scalar processor during the same clock cycle(s).

The foregoing exemplary architecture enables the implementation a powerful, yet manageable instruction set that maximizes the data throughput afforded by the parallel execution units of the PPU. Generally speaking, each one of a plurality of Vector Processing Engines (VPEs) comprises a plurality of Vector Processing Units (VPUs). Each VPU is adapted to execute two (or optionally more) instruction threads using dual (or a corresponding plurality of) data processing units capable of accessing data from a common (primary) VPU memory and a set of shared registers. Each processing unit enables independent thread execution using dedicated logic execution units including, as a currently preferred example; a vector processor comprising multiple Floating-Point vector arithmetic Units (FPUs), and an scalar processor comprising at least one of an Arithmetic Logic Unit (ALU), a Load/Store Unit (LSU), a Branching Unit (BRU), and a Predicate Logic Unit (PLU).

Given this hardware architecture, several general categories of VPU instructions find application within the present invention. For example, the FPUs, taken collectively or as individual execution units, perform Single Instruction Multiple Data (SIMD) floating-point operations on the floating point vector data so frequently associated with physics problems. That is, highly relevant (but perhaps also unusual in more general computational settings) floating point instructions may be defined in relation to the floating point vectors commonly used to mathematically express physics problems. These quasi-customized instructions are particularly effective in a parallel hardware environment specifically designed to resolve physics problems. Some of these FPU specific SIMD operations include, as examples:
FMADD—wherein the product of two vectors is added to an accumulator value and the result stored in designated memory address;
FMSUB—wherein product of two vectors is subtracted from an accumulator value and the result stored in designated memory address;
FMSUBR—wherein an accumulator value is subtracted from the product of two vectors and the result stored in designated memory address;
FDOT—wherein the dot-product of two vectors is calculated and the result stored in designated memory address;
FADDA—wherein elements stored in an accumulator are pair-wise added and the result stored in designated memory address;

Similarly, a highly relevant, quasi-customized instruction set may be defined in relation to the Load/Store Units operating within a PPU designed in accordance with the present invention. For example, taking into consideration the prevalence of related 3 and 4 word data structures normally found in physics data, the LSU-related instruction set includes specific instructions to load (or store) 3 data words into a designated memory address and a 4^{th} data word into a designated register or memory address location.

Predicate logic instructions may be similarly defined, whereby intermediate data values are defined or logic operations (AND, OR, XOR, etc.) are applied to data stored in predicate register and/or source operands.

When compared to the general instructions available in conventional CPU instruction sets, the present invention provides a set of well-tailored and extremely powerful tools specifically adapted to manage and resolve the types of data necessarily arising from the mathematical expression of complex physics problems. When combined with a hardware architecture characterized by the presence of parallel mathematical/logic execution units, the instruction set of the present invention enables sufficiently rapid resolution of the underlying mathematics, such that complex physics-based animations may be displayed in real-time.

As previously noted, data throughput is another key aspect which must be addressed in order to provide real-time physics-based animations. Conventional CPUs often seek to increase data throughput by the use of one or more data caches. The scheme of retaining recently accessed data in a local cache works well in many computational environments because the recently accessed data is statistically likely to be “re-accessed” by near-term, subsequently occurring instructions. Unfortunately, this is not the case for many of the algorithms used to resolve physics problems. Indeed, the truly random nature of the data fetches required by physics algorithms makes little if any positive use of data caches.

Accordingly in one related aspect, the hardware architecture of the present invention eschews the use of data caches in favor of a multi-layer memory hierarchy. That is, unlike conventional CPUs the present invention, as presently preferred, does not use cache memories associated with a cache controller circuit running a “Least Recently Used” replacement algorithm. Such LRU algorithms are routinely used to determine what data to store in cache memory. In contrast, the present invention prefers the use of a programmable processor (e.g., the MCU) running any number of different algorithms adapted to determine what data to store in the respective memories. This design choice, while not mandatory, is well motivated by unique considerations associated with physics data and the expansive execution of mathematical/logic operations resolving physics problems.

At a lowest level, each VPU has some primary memory associated with it. This primary memory is local to the VPU and may be used to store data and/or executable instructions. As presently preferred, primary VPU memory comprises at least two data memory banks that enable multi-threading operations and two instruction memory banks.

Above the primary memories, the present invention provides one or more secondary memory. Secondary memory may also store physics data and/or executable instructions. Secondary memory is preferably associated with a single VPE and may be accessed by any one of constituent VPUs. However, secondary memory may also be accessed by other VPE's. However, secondary memory might alternatively be associated with multiple VPEs or the DME. Above the one or more secondary memory is the PPU memory generally storing physics data received from a host system. Where present, the PCE provides a highest (whole chip) level of programmability. Of note, any memory associated with the PCE, as well as the secondary and primary memories may store executable instructions in addition to physics data.

This hierarchy of programmable memories, some associated with individual execution units and others more generally accessible, allows exceptional control over the flow of physics data and the execution of the mathematical and logic operations necessary to resolve a complex physics problem. As presently preferred, programming code resident in one or more circuits associated with a memory control functionality (e.g., one or more MCUs) defines the content of individual memories and controls the transfer of data between memories. That is, an MCU circuit will generally direct the transfer of data between PPU memory, secondary memory, and/or primary memories. Because individual MCU and VPU circuits, as well as the optionally provided PCE and DME resident circuits, can all be programmed, the system designer's task of efficiently programming the PPU is made easier. This is true for both memory-related and control-related aspects of programming.

1. A Physics Processing Unit (PPU), comprising:
a PPU memory storing at least physics data;
a plurality of parallel connected Vector Processing Engines (VPEs), wherein each one of the plurality of VPEs comprises a plurality of Vector Processing Units;
a Data Movement Engine (DME) providing a data transfer path between the PPU memory and the plurality of VPEs; and,
at least one programmable Memory Control Unit (MCU) controlling the transfer of physics data from the PPU memory to at least one of the plurality of VPEs.

2. The PPU of claim 1, wherein the MCU further comprises a single, centralized, programmable memory control circuit resident in the DME, wherein the MCU controls all data transfers between the PPU memory and the plurality of VPEs.

3. The PPU of claim 1, wherein the MCU further comprises a distributed plurality of programmable memory control circuits, each one of the distributed plurality of programmable memory control circuits being resident in a respective VPE and controlling the transfer of physics data between the PPU memory and the respective VPE.

4. The PPU of claim 3, wherein the MCU further comprises an additional programmable memory control circuit resident in the DME, wherein the additional programmable memory control circuit functionally cooperates with the distributed plurality of programmable memory control circuits to control the transfer of physics data between the PPU memory and the plurality of VPEs.

5. The PPU of claim 3, further comprising:
a PPU Control Engine (PCE) comprising a master programmable memory control circuit controlling overall operation of the PPU.

6. The PPU of claim 5, wherein the PCE further comprises circuitry adapted to communicate data between the PPU and a host system.

7. The PPU of claim 6, wherein the DME further provides a data transfer path between the host system, the PPU memory, and the plurality of VPEs.

8. The PPU of claim 1, wherein at least one of the plurality of VPEs further comprises:
a programmable Memory Control Unit (MCU) controlling the transfer of at least physics data between the PPU memory and at least one of the plurality of VPEs; and,
a plurality of parallel connected Vector Processing Units (VPUs), wherein each one of the plurality of VPUs comprises a plurality of data processing units.

9. The PPU of claim 8, wherein each VPU further comprises:
a common memory/register portion comprising a VPU memory storing at least physics data; and,
wherein each one of the plurality of data processing units respectively accesses physics data stored in the common memory/register portion and executes mathematical and logic operations in relation to the physics data.

10. The PPU of claim 9, wherein each one of the plurality of data processing units further comprises:
a vector processor comprising a plurality of floating-point execution units; and
an scalar processor comprising a plurality of scalar operation execution units.

11. The PPU of claim 10, wherein the plurality of scalar operation execution units further comprises at least one unit selected from a group of units consisting of: an Arithmetic Logic Unit (ALU), a Load/Store Unit (LSU), a Predicate Logic Unit (PLU), and a Branching Unit (BRU).

12. The PPU of claim 11, wherein the common memory/register portion further comprises at least one set of registers selected from a group of defined registers sets consisting of: predicate registers, shared scalar registers, synchronization registers, and data communication registers.

13. The PPU of claim 11, wherein the vector processor comprises three floating-point execution units arranged on parallel and adapted to execute floating-point operations on vector data contained in the physics data.

14. The PPU of claim 13, wherein the vector processor comprises a plurality of floating-point accumulators and a plurality of general floating-point registers receiving data from the VPU memory.

15. The PPU of claim 13, wherein the scalar processor further comprises a program counter.

16. The PPU of claim 15, wherein the scalar processor further comprises least one set of registers selected from a group of defined registers sets consisting of: status registers, scalar registers, and extended registers.

17. The PPU of claim 16, wherein the VPU memory comprises a plurality of memory banks adapted to multi-thread operations.

18. The PPU of claim 7, wherein the DME further comprises:
a connected series of crossbar circuits respectively connecting the PPU memory, the plurality of VPEs, and a data transfer port connecting the PPU to the host system.

19. The PPU of claim 18, wherein the PCE controls at least one data communications protocol adapted to transfer at least physics data from the host system to the PPU memory, wherein the at least one data communications protocol is selected from a group of protocols defined by USB, USB2, Firewire, PCI, PCI-X, PCI-Express, and Ethernet.

20. A Physics Processing Unit (PPU), comprising:
a PPU memory storing at least physics data;
a plurality of Vector Processing Engines (VPEs) connected in parallel; and,
a Data Movement Engine (DME) providing a data transfer path between the PPU memory and the plurality of VPEs;
wherein each one of the plurality of VPEs further comprises:
a secondary memory associated with the VPE and receiving at least physics data from the PPU memory via the DME; and
a plurality of Vector Processing Units (VPUs) connected in parallel,
wherein each one of the plurality of VPUs comprises a primary memory receiving at least physics data from at least the secondary memory.

21. The PPU of claim 20, wherein the PPU further comprises:
a Memory Control Unit (MCU) comprising at least one programmable control circuit controlling the transfer of data between at least the PPU memory and the plurality of VPEs.

22. The PPU of claim 21, wherein the at least one programmable control circuit comprises a distributed plurality of programmable memory control circuits, each one of the distributed plurality of programmable memory control circuits being resident in a respective VPE and controlling the transfer of data between the PPU memory and the respective VPE.

23. The PPU of claim 22, wherein each one of the distributed plurality of programmable memory control circuits further controls the transfer of data from the secondary memory to one or more of the primary memories resident in the respective VPE.

24. The PPU of claim 23, wherein the MCU further comprises an additional programmable memory control circuit resident in the DME, wherein the additional programmable memory control circuit functionally cooperates with the distributed plurality of programmable memory control circuits to control the transfer of data between the PPU memory and the plurality of VPEs.

25. The PPU of claim 24, wherein the MCU further comprises a master programmable memory control circuit resident in a PPU Control Engine (PCE) on the PPU.

26. A Physics Processing Unit (PPU), comprising:
a PPU memory storing at least physics data;
a plurality of Vector Processing Engines (VPEs) connected in parallel; and,
a Data Movement Engine (DME) providing a data transfer path between the PPU memory and the plurality of VPEs;
wherein each one of the plurality of VPEs comprises:
a secondary memory associated with the VPE and receiving at least physics data from the PPU memory via the DME; and
a plurality of Vector Processing Units (VPUs) connected in parallel,
wherein each one of the plurality of VPUs comprises a primary memory receiving at least physics data from at least the secondary memory; and,
wherein each one of the plurality of VPUs implements at least first and second execution threads in relation to physics data stored in primary memory.

27. The PPU of claim 26, wherein each one of the plurality of VPUs comprises a common memory/register portion including the primary memory; and,
first and second parallel connected data processing units respectively accessing data in the common memory/register portion, and respectively implementing the first and second execution threads by executing mathematical and logic operations defined by respective instruction sets defining the first and second execution threads.

28. The PPU of claim 27, wherein each one of the first and second parallel connected data processing units further comprises:
a vector processor comprising a plurality of floating-point execution units; and
an scalar processor comprising a plurality of scalar operation execution units.

29. The PPU of claim 28, wherein the plurality of scalar operation execution units comprises at least one execution unit selected from a group of execution units consisting of: an Arithmetic Logic Unit (ALU), a Load/Store Unit (LSU), a Predicate Logic Unit (PLU), and a Branching Unit (BRU).

30. The PPU of claim 29, wherein the common memory/register portion further comprises at least one set of registers selected from a group of defined registers sets consisting of: predicate registers, shared scalar registers, synchronization registers, and data communication registers.

31. The PPU of claim 29, wherein the vector processor comprises three floating-point execution units arranged on parallel and adapted to execute floating-point operations on vector data contained in the physics data.

32. The PPU of claim 31, wherein the vector processor further comprises a plurality of floating-point accumulators and a plurality of general floating point registers receiving data from at least the primary memory.

33. The PPU of claim 32, wherein the scalar processor further comprises a program counter.

34. The PPU of claim 27, wherein each one of the first and second data processing units responds to a respective Very Long Instruction Word (VLIW) received in the VPU.

35. The PPU of claim 34, wherein the VLIW comprises a first slot containing first instruction code directed to the vector processor and a second slot containing second instruction code directed to the scalar processor.

36. A Physics Processing Unit (PPU), comprising:
a plurality of parallel connected Vector Processing Engines (VPEs), each VPE comprising a plurality of mathematical/logic execution units performing mathematic and logic operations related to the resolution a physics problem defined by a body of physics data stored in a PPU memory; and,
a hierarchical architecture of memories comprising:
a secondary memory associated with a VPE receiving data from the PPU memory; and,
a plurality of primary memories, each primary memory being associated with a corresponding group of mathematical/logic execution units and receiving data from at least the secondary memory;
wherein the transfer of data between the PPU memory and the secondary memory, and the transfer of data between the secondary memory and the plurality of primary memories is controlled by programming code resident in the plurality of VPEs.

37. The PPU of claim 36, wherein the transfer of data between the secondary memory and the plurality of primary memories is further controlled by programming code resident in circuitry associated with each group of mathematical/logic execution units.

38. The PPU of claim 37, further comprising:
a PPU Control Engine (PCE) controlling overall operation of the PPU and communicating data from the PPU to a host system; and
a Data Movement Engine (DME) providing a data transfer path between the PPU memory and the secondary memory;
wherein the transfer of data between the PPU memory and the secondary memory is further controlled by programming code resident in the DME.

39. The PPU of claim 38, wherein the transfer of data between the PPU memory and the secondary memory is further controlled by programming code resident in PCE.
